(19) United States
(12) Patent Application Publication
(10) Pub. No.: US 2002/0001401 A1
(43) Pub. Date: Jan. 3, 2002

(54) Medical system architecture with an apparatus for the acquisition and playback of current photographic images or image sequences

(75) Inventor: Siegfried Bocionek, Erlangen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 09/885,617

(22) Filed: Jun. 20, 2001

(30) Foreign Application Priority Data
Jun. 29, 2000 (DE) 10031779.0

(51) Int. Cl. G06K 9/00

(52) U.S. Cl. 382/128

(57) ABSTRACT

A medical system architecture with a modality for the acquisition of examination images, with an apparatus allocated to the modality for processing the examination images, an apparatus for the transmission of the examination images that works according to the DICOM method for data exchange between various applications, an apparatus for storing the examination images, and with further devices for the post-processing of the examination images. Cameras are connected to the devices for the processing and post-processing of the examination images. The devices have monitors and are fashioned such that current photographic images or image sequences of the cameras can be mixed in next to the examination images in a separate window on the monitors.

### BACKGROUND OF THE INVENTION

1. Field of the Invention

The present invention is directed to a medical system architecture of the type having a modality for the acquisition of examination images, with an apparatus allocated to the modality for processing the examination images, an apparatus for the transmission of the examination images that operates according to the DICOM method for data exchange between various applications, an apparatus for storing the examination images, and with further devices for post-processing the examination images.

2. Description of the Prior Art

Medical system architectures are known from the book Bildgebende Systeme für die medizinische Diagnostik, edited by H. Morneburg, 3^{rd} Edition, 1995, pages 684 if, wherein image viewing locations and image processing locations, referred to as workstations, are connected to an image communication system for fetching patient data and images generated by modalities.

Monitoring cameras for monitoring the patient at or in a large-scale apparatus, for example an MR apparatus, are known. The image is displayed on an extra monitor.

German OS 198/ 02 572 discloses a medical system architecture wherein photographic images can be acquired and stored in common with the examination images. These can serve for the identification of the patient or for the documentation of medical, diagnosis-relevant documents, reports, graphics or optical images.

### SUMMARY OF THE INVENTION

An object of the present invention is to provide a medical system architecture of the type initially described that enables a presentation of images that are registered with video and/or digital cameras on the console or backup console computer of a medical diagnosis or therapy apparatus. Such an apparatus can be an MR, CT, ultrasound, X-ray or angiography apparatus, nuclear camera, supervision monitor, diagnostics workstation or an irradiation device.

The object is inventively in a medical system architecture wherein cameras are connected to the devices for the processing and post-processing of the examination images, those devices having monitors and being fashioned such that current photographic images or image sequences (i.e., at least one still image) of the cameras can be mixed in next to the examination images in a separate window on the monitors.

Advantageously, the current photographic images or image sequences of the cameras can be reproduced on the monitor of a separately arranged device, so that a physician can observe an examining attendant. The camera can thereby be allocated to a first device whose images are reproduced on the monitor of a second device, so that the physician can give instructions to an MTRA (medical-Technical Radiology Assistant).

When the device for the transmission of the examination images is inventively fashioned such that is transmits the photographic images or image sequences of the cameras to viewing workstations connected to the device, a medical system architecture is obtained that has a device for video conference, an application for medical diagnosis and therapy devices as well as medical viewers and workstations.

Inventively, the cameras can be monitoring cameras that, for example, are pivotable, whereby the cameras can advantageously be digital cameras and/or video cameras.

The cameras of one device can be remotely controlled proceeding from a different device, so that, for example, a physician can observe an examining person in targeted fashion and give instructions for the execution of an examination.

### DESCRIPTION OF THE DRAWINGS

FIG. 1 shows an example of a system architecture of a medical image communication network.

FIG. 2 is a schematic illustration of a part of the inventive system architecture.

### DESCRIPTION OF THE PREFERRED EMBODIMENTS

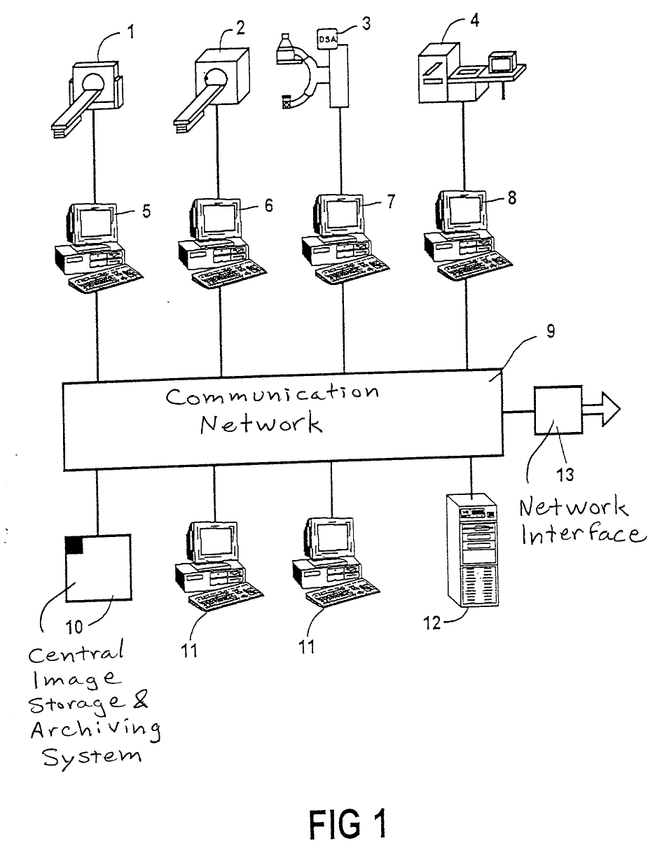

As an example, FIG. 1 shows the system architecture of a medical image communication network. The modalities 1 through 4 serve for the acquisition of medical images. As image-generating systems, these can be, for example, a CT unit 1 for computed tomography, an MR unit 2 for magnetic resonance, a DSA unit 3 for digital subtraction angiography and an X-ray unit 4 for digital radiography. Operator consoles 5 through 8 of the respective modalities or workstations are connected to these modalities 1 through 4, allowing the acquired medical images to be processed and locally stored. Patient data belonging to the images also can be entered.

The operator consoles 5 through 8 are connected to an image communication network 9 in the form of a LAN/WAN backbone for the distribution of the generated images and for communication. Thus, for example, the images generated in the modalities 1 through 4 and the images further-processed in the operator consoles 5 through 8 can be stored in a central image storage and image archiving system 10, or can be forwarded to other workstations.

Further viewing stations 11 in the form of diagnostics consoles that have local image memories are connected to the image communication network 9. Such a viewing workstation 11, for example, is a very fast mini-computer employing one or more fast processors. The images that have been acquired and deposited in the image archiving system 10 can be subsequently fetched for diagnosis at the viewing workstations 11 and deposited in its local image memory, from which the images are immediately available to the diagnostician working at the viewing workstation.

Servers 12, for example, patient data servers (PDS), file servers, program servers and/or EPR (Electronic Patient Record) servers also are connected to the image communication network 9. The image and data exchange via the image communication network 9 ensues according to the DICOM (Digital Imaging and Communications in Medicine) standard, which is an industry standard for the transmission of images and other medical information between computers, so that a digital communication between diagnosis and therapy installations of different manufacturers is possible. A network interface 13 via which the internal image communication network 9 is connected to a global data network, for example the World Wide Web, can be connected to the image communication network 9, so that the standardized data can be exchanged with different networks worldwide.

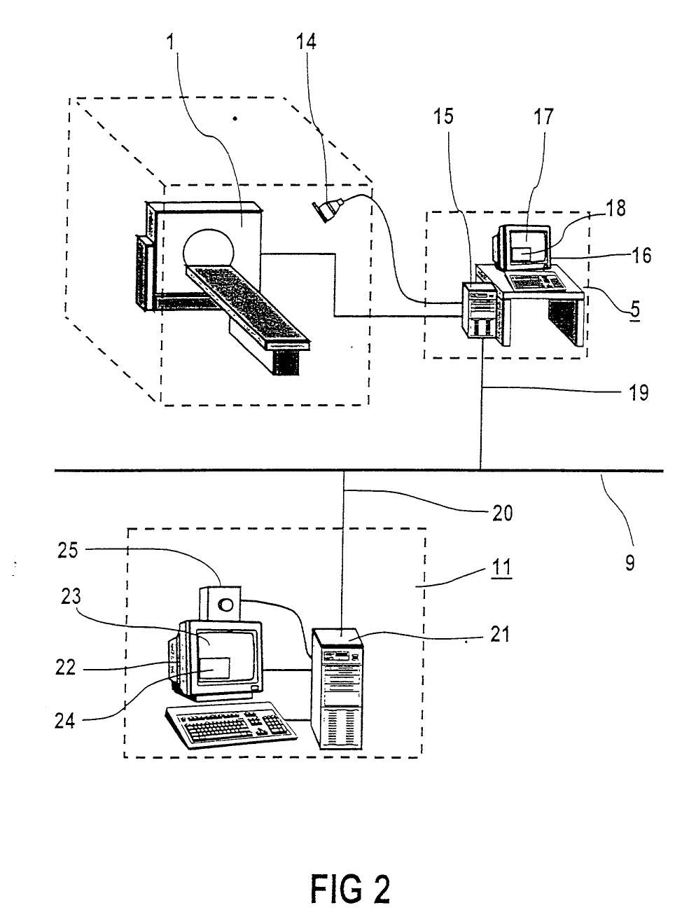

FIG. 2 schematically shows a part of the inventive system architecture of the medical image communication network with the CT unit 1 for computer tomography as an exemplary modality. A pivotable camera, for example a video camera 14, is arranged in the examination room, this camera 14 being connected to a console computer 15 of the operator console 5. A window 18 for the playback of the photographic images or image sequences registered with the video camera 14 is provided on the picture screen 17 of a monitor 16 of the operator console 5. The console computer 15 is connected to the image communication network 9 via LAN/WAN terminal 19.

Each viewing workstation 11, which has a computer 21 and a monitor 22, also is connected to the image communication network 9 via a LAN/WAN terminal 20. A window 24 for the playback of photographic images or image sequences that, for example, can likewise be registered by the video camera 14, is provided on the picture screen 23 of the monitor 22. A video camera 25, for example, is also connected to the computer 21 of the viewing workstation 11. A physician can make the findings registered therewith available for a video conference with, for example, a specialist at another viewing workstation 11. Instead of video cameras 14 and 25, digital still picture cameras with which photographic still pictures can be continuously made alternatively can be utilized.

As a result of the inventive fashioning of the system architecture with video and/or digital cameras 14 and 25, arbitrary images or image sequences that proceed beyond the diagnostic images generated by the modalities that are currently exclusively displayed can be presented on the console or backup console computer of the medical diagnosis and/or therapy devices. Ultrasound devices, nuclear cameras, supervision monitors, irradiation devices or the like also can be provided instead of the illustrated modalities 1-4.

As a result of the connection of cameras to the console and/or backup console computer, as well as of the installation of video conferencing software, images as still pictures or image sequence from the immediate surroundings of the device can be viewed as “digital video sequences” on the console picture screen. When the computer is networked, video images and/or sequences from everywhere else in the network also can be transmitted to the console computer and played thereat.

As a result of the combination of the technology of the video conference with the medical applications and display technologies on the computer consoles of medical devices, the possibility is provided of playing back images registered with video and/or digital cameras on the console or backup console computer of a medical diagnosis or therapy device. The integration of the video conferencing application simplifies and facilitates the workflow of the medical workstation realized at the device, for example in macro-functions, validation routines, monitoring functions and online consulting options.

Applied examples of such examinations or findings with an inventive video camera can be:

a) For monitoring the patient at and/or in the modality 1 through 4, the image of the monitoring camera is not—as is currently standard—played back on an extra monitor but in the video conferencing window 18 on the console computer.

b) For supervising and/or assisting the medical-technical radiology assistant (MTRA), a physician who is not in the proximity of the device sees the operation of the device at his diagnosis workstation. He or she can instruct the MRTA about how the device is to be operated in order to achieve optimum results.

c) Given an on-call radiology from at home, the physician is on call at home, for example on the weekend or during the night. Via a remote access and without a time delay, he or she can assist the MTRA in the initial diagnosis of, for example, an emergency patient.

d) The inventive apparatus also can be advantageously utilized in tele-radiology, diagnosis and/or therapy in prisons or in military deployments. The physician is seated at a viewing workstation 11 connected via network while an MTRA undertakes the medical application at said places under the supervision of the physician.

e) In a specialist discussion or consultation, two physicians—via two respective diagnosis consoles of viewing workstations 11—discuss a case online, whereby they can see each other in the video conferencing window as a result of the video cameras 25. At the same time, however, the video camera 14 can also be directed onto the patient of other details of the case. Diagnostic images or the like can even be synchronously processed visible at both sides via shared applications.

Although modifications and changes may be suggested by those skilled in the art, it is the intention of the inventor to embody within the patent warranted hereon all changes and modifications as reasonably and properly come within the scope of his contribution to the art.

I claim as my invention:

1. A medical system architecture comprising:
at least one modality for acquiring an examination image of a subject;
a processing apparatus connected to said modality for processing said examination image;
a storage system for storing said examination image;
a post-processing device for post-processing said examination image;
a communication network operating according to a DICOM standard for exchanging data representing at least said examination image among said processing apparatus, said storage apparatus and said post-processing device;
said processing apparatus having a viewing monitor on which said examination image is displayed; and
a camera having a field of view encompassing said modality for producing at least one still image of said modality, said camera being connected to said processing device and said processing device mixing said at least one still image of said modality into said examination image in a separate window on said viewing monitor.

2. A medical system architecture as claimed in claim 1 wherein said camera produces a sequence of still images of said imaging modality.

3. A medical system architecture as claimed in claim 1 wherein said post-processing device has a viewing monitor on which said examination image is displayed together with said window containing said at least one still image of said modality.

4. A medical system architecture as claimed in claim 3 further comprising a camera at said post-processing device having a field of view for producing at least one still image of an environment of said post-processing device, and wherein said processing apparatus mixes said at least one still image of said environment of said post-processing device into said window on the viewing monitor at said processing apparatus, for video conferencing.

5. A medical system architecture as claimed in claim I wherein said post-processing device is a first post-processing device having a first viewing monitor and a first camera for producing at least one first still image of an environment of said first post-processing device, and wherein said medical system architecture further comprises a second post-processing device connected to said communication network, said second post-processing device having a second viewing monitor and a second camera for producing at least one second still image of an environment of said second post-processing device, said first post-processing device mixing said at least one second still image into a window at said first viewing monitor and said second post-processing device mixing said at least one first still image into a window at said second monitor, for video conferencing between said first and second post-processing devices.

6. A medical system architecture as claimed in claim 1 wherein said camera is a digital camera.
